(19) United States
(12) Patent Application Publication
(10) Pub. No.: US 2013/0212537 A1
(43) Pub. Date: Aug. 15, 2013

(54) Extracting Feature Information From Mesh

(71) Applicant: James Hall, Poway, CA (US)

(72) Inventor: James Hall, Poway, CA (US)

(73) Assignee: ADOBE SYSTEMS INCORPORATED, San Jose, CA (US)

(21) Appl. No.: 11/553,199

(22) Filed: Oct. 26, 2006

Related U.S. Application Data
(63) Continuation of application No. 11/469,289, filed on Aug. 31, 2006, now abandoned.

(51) Int. Cl. G06F 3/0481

(52) U.S. Cl. CPC G06F 3/04815
USPC 715/849

(57) ABSTRACT

A method includes displaying a three-dimensional shape in a view generated by a viewing tool. The three-dimensional shape represented as a mesh can be obtained from a CAD or other 3D modeling tool. The mesh obtained from one of these sources can contain a high percentage of data points and edges that while required for display purposes, are of no interest to the measurement process. The method simplifies the measurement process by extracting important feature information from the mesh. The method includes receiving, while the three-dimensional shape is displayed, positional input generated by a user placing a cursor at a selected point in the view. The method includes determining an appropriate feature on the mesh as a function of the user input and the mesh, to be made available for measurement purposes. The method includes generating an output from the viewing tool that indicates the selected feature.

### RELATED APPLICATIONS

This application is a continuation (and claims the benefit of priority under 35 USC 120) of U.S. application Ser. No. 11/469,289, filed Aug. 31, 2006. The disclosure of the prior application is considered part of (and is incorporated by reference in) the disclosure of this application.

### BACKGROUND

This specification relates to digital graphics data processing.

Computer-based three-dimensional models are generated in many different situations. Such models can be used for planning purposes, design work, and product development, to name a few examples. Such models can be generated using any of a category of computer software programs that is broadly referred to as 3D modeling applications. One group of 3D application is computer-aided design (CAD) programs. The CAD programs are usually complex and powerful tools that let a user create a multitude of different models and perform many types of operations on them. Other examples of 3D applications include the 3D art programs used in the games and computer animation industry. 3D applications often require special training to use them.

There are, however, also situations where it can be of interest to view a computer-based three-dimensional model outside the 3D modeling environment. For example, users who are not skilled in operating the 3D modeling application may want to study a generated model and learn some information about it. As another example, some 3D applications are tied to a particular system environment or platform, which can impact the ability to export the generated models for use on another platform, such as one in a handheld or otherwise mobile device, when system resources can be more limited.

### SUMMARY

The invention relates to extracting feature information from a mesh.

In a first general aspect, a computer-implemented method includes displaying a view that includes a three-dimensional shape defined by a mesh of polygons. The method includes receiving, while the three-dimensional shape is displayed, a first input generated by a user selecting a point in the view. The method includes searching the mesh, in response to the first input, to identify any visible transition feature of the displayed three-dimensional shape near the selected point. The method includes generating an output that indicates an outcome of the search.

Implementations can include any or all of the following features. Searching the mesh can include determining whether the three-dimensional shape has a silhouette near the selected point. Determining whether the three-dimensional shape has a silhouette near the selected point can include determining an angle between a normal vector of a first polygon and a view direction defined in the view, the first polygon including the selected point, and determining an angle between a normal vector of a second polygon and the view direction, the second polygon being adjacent the first polygon, wherein the three-dimensional shape is determined to have a silhouette near the selected point if one of the angles is acute and another one of the angles is obtuse. Determining whether the three-dimensional shape has a silhouette near the selected point can further include iteratively evaluating adjacent polygons to determine whether the silhouette is a circle silhouette, an arc silhouette or a linear silhouette. It can be determined that the three-dimensional shape does not have a silhouette near the selected point, and the method can further include determining whether the three-dimensional shape has a circle near the selected point. It can be determined that the three-dimensional shape does not have a circle near the selected point, and the method can further include determining whether the three-dimensional shape has a linear edge near the selected point. When no visual transition feature is identified in searching the mesh the output can indicate that the selected point has been selected for a measurement operation. When the visual transition feature is identified in searching the mesh, the output can indicate that the identified visual transition feature has been selected for a measurement operation. The method can further include performing the measurement operation using the selected visual transition feature and not using any additional visual transition feature. Performing the measurement operation can include (i) determining a property of a circle or arc, or (ii) determining a length of an edge. The user can select another point in the view, and the method can further include performing the measurement operation using (i) the selected visual transition feature, and (ii) the other selected point or another visual transition feature near the other selected point, the other visual transition feature identified by searching the mesh. Performing the measurement operation can include determining a distance between any two features selected from the group consisting of a circle, an arc and an edge.

In a second general aspect, a system includes a user interface device and one or more computers. The one or more computers are operable to interact with the user interface device and to cause the user interface device to present a view that includes a three-dimensional shape defined by a mesh of polygons. The one or more computers are also operable to search the mesh, in response to user selection of a point in the view, to identify any visible transition feature of the displayed three-dimensional shape near the selected point, and generate an output that indicates an outcome of the search for presentation on the user interface device.

Implementations can include any or all of the following features. The one or more computers can include a server operable to interact with the user interface device through a data communication network, and the user interface device can be operable to interact with the server as a client. The one or more computers can include one personal computer, and the personal computer can include the user interface device.

Particular embodiments of the subject matter described in this specification can be implemented to realize one or more of the following advantages. Feature information can be extracted from a mesh in a viewing tool that is not configured for 3D modeling. A mesh can be searched to identify a visual transition feature for use in a measurement operation. A snap feature can be provided for use with a 3D polygonal mesh in an environment where substantially no modeling information about the mesh is available.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of a computer device used for viewing three-dimensional shapes.

FIG. 2 is an exemplary illustration of shapes represented in different models.

FIG. 3 shows an example of a shape with a silhouette.

FIG. 4A shows a flow chart of an example of a method that identifies a feature of interest on a three-dimensional shape represented by a tessellated mesh.

FIG. 4B shows a flow chart of an example of a method used for measuring features that have been selected on a three-dimensional shape.

Like reference numbers and designations in the various drawings indicate like elements.

### DETAILED DESCRIPTION

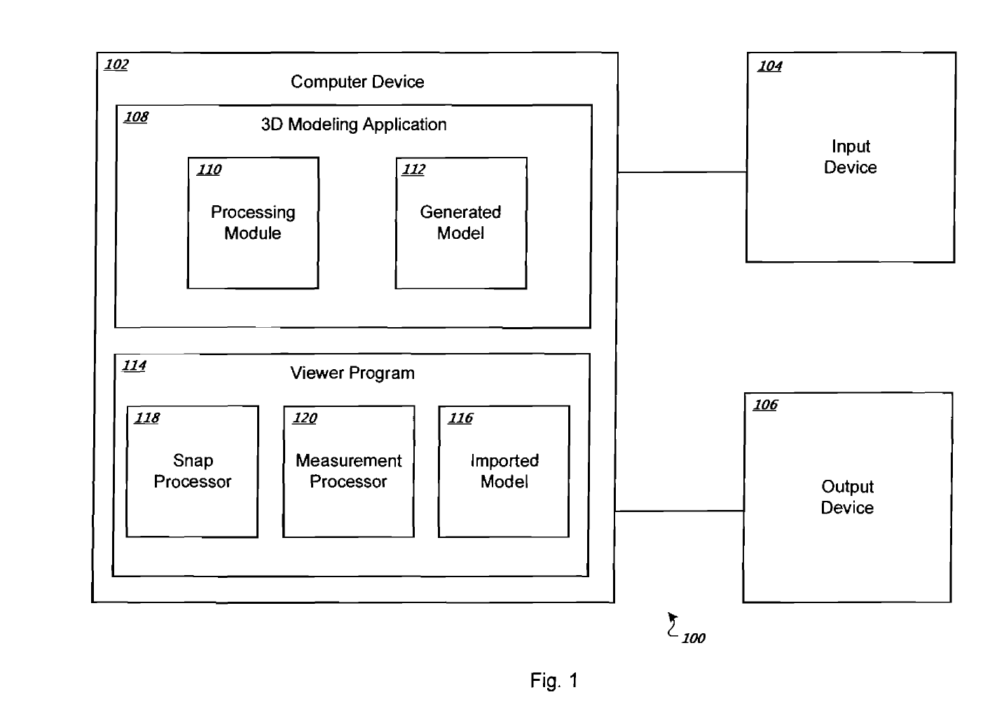

FIG. 1 is a block diagram of a computer system 100 that includes a computer device 102. The computer device 102 is used for viewing a three-dimensional shape, for example in form of polygonal mesh that represents a physical object. Here, the computer device 102 is connected to at least one input device 104 and to at least one output device 106. The computer device 102 has access to a three-dimensional (3D) modeling application 108, for example a computer-aided design (CAD) program. The 3D modeling application 108 has a processing module 110 for generating three-dimensional features such as blocks, shapes and holes. The processing module 110 can create a generated model 112 which can be used for various 3D purposes. Generally, the generated model 112 contains semantic information regarding one or more 3D features that have been generated. A mesh obtained from the 3D modeling application 108 can contain a high percentage of data points and edges that, while required for display purposes, are of no interest to the measurement process. Systems and techniques described herein can simplify the measurement process by extracting feature information from the mesh.

The computer device 102 has a viewer program 114 for viewing shapes, including the shapes generated using the 3D modeling application 108. The viewer program 114 does not perform 3D modeling. Rather, the viewer program 114 can process 3D models received from a 3D modeling application to allow users to view them. In some implementations, the viewer program is a version of the Adobe® Reader® program that has been configured to conform to one or more aspects of this description. The viewer program can be provided as a plug-in application to another program. The viewer program 114 can be located on the same device as the 3D modeling application 108 or on a different device. The output of the viewer program 114 can be presented in a user interface generated on the output device 106, which in some implementations includes a personal computer separate from the computer device 102.

The viewer program 114 obtains an imported model 116 by importing the generated model 112 from the 3D modeling application 108. For example, importing the generated model 112 into the viewer program 114 allows for the viewing of shapes by those users who do not have access to, or who otherwise do not want to use, the 3D modeling application 108. The imported model 116 can be a tessellated mesh of polygons that define the outer boundaries of a 3D object. For example, the generated model 112 can contain semantic information describing important features such as profiles, holes, filets, chamfers, etc., but the tessellated mesh will not contain this feature information about the 3D shapes. Rather, the tessellated mesh can consist of many edges that would likely not be of interest for measurements.

The viewer program 114 displays a three-dimensional shape on the output device 106 based on the imported model 116. This allows a user to see the three-dimensional model and can also provide for measurements to be taken on the shape, for example as will now be described. The viewer program 114 has a snap processor 118 that selects a feature for a measurement when the user points at the three-dimensional shape generated from the imported model 116. For example, as the user moves the cursor over the shape, the snap processor can highlight one or more significant features in the geometry such as linear edges, circle edges, arc edges, circle center points, etc. The snap processor 118 uses the currently selected point and the mesh to select one or more interesting features.

The viewer program 114 has a measurement processor 120 for performing a measurement operation on the mesh. The measurement operation can be used on one or more selected features, for example the distance between edges, the length of an edge, the angle of an arc or the radius of a circle. The result of the measurement can be presented to the user, for example as a measurement value displayed near the measured feature(s).

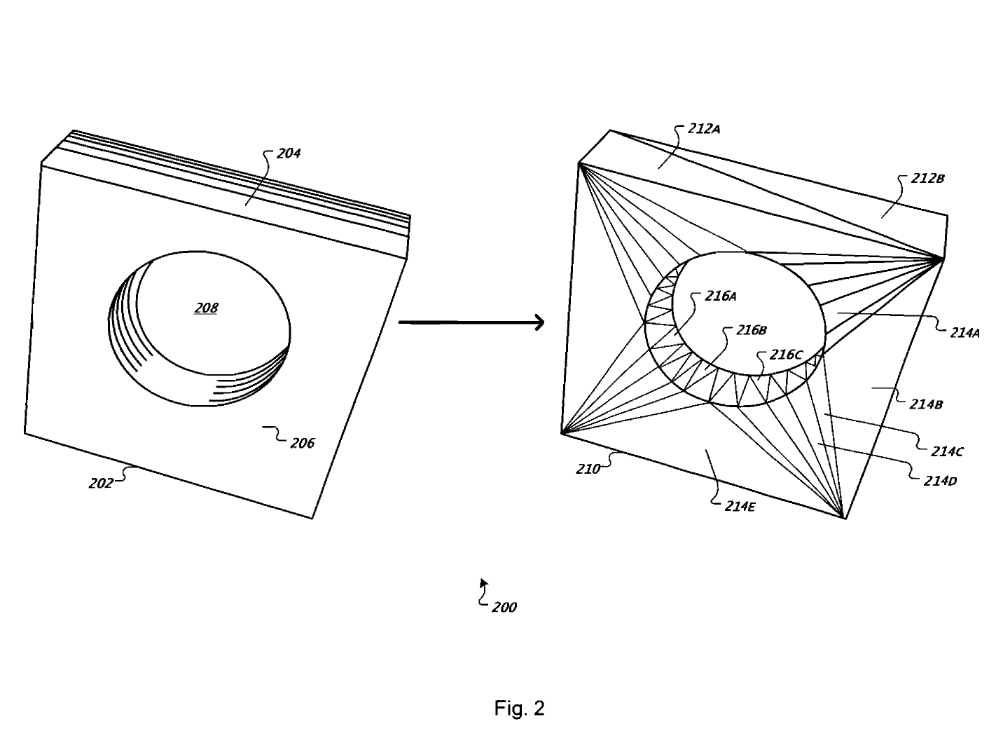

FIG. 2 schematically shows a transition 200 from a CAD model to a mesh. The transition is shown with exemplary shapes illustrating how shape information can be stored differently in different representations. For example, the CAD program 108 can store semantics describing a block shape 202 in the generated model 112. Examples of semantics that can be stored are: information representing that the shape has certain edges 204 and 206 of particular lengths and heights at particular locations, and oriented at particular angles. As another example, semantics can be stored regarding a hole 208, such as its radius and its location. These semantics can be input into the CAD program 108 to generate the block shape 202, and can therefore be available in that environment.

The viewer program 114 can import the block shape 202 as the imported model 112, but semantic information about three-dimensional shapes will be lost in some implementations. The block shape 202 can be represented in the imported model 112 as a tessellated mesh representation corresponding to a block shape 210. A tessellated mesh can be created through a process of polygon triangulation, where each polygon is decomposed into a set of triangles. For example, the block shape 210 can be stored as a set of several triangles. The top edge of the block can be represented by triangles 212A and 212B. The front face of the block can be represented by a set of triangles such as 214A, 214B, 214C, 214D, 214E and others. The inner part of the block made visible by the hole can be represented by triangles 216A, 216B, 216C and others. A similar triangulation process can be used to represent any other geometric information of the block shape 202 as a tessellated mesh. The mesh can use another form of polygon other than a triangle. Thus, while the block shape 210 corresponds to the geometrical features of the shape 202 from the CAD program, it does so by an aggregation of points that define the triangles that make up the shape. Moreover, the mesh that makes up the shape 210 does not have any inherent semantic information as to which of the triangle edges that represent the actual geometric features of the shape. Taking the triangle 212A as an example, two of its edges form the respective boundaries where different sides of the shape meet. These two edges of the triangle are particularly interesting because users sometimes wish to measure distances from one side of the shape to another. The third edge, in contrast, is merely a diagonal across one of the shape's faces. This edge does not have the same geometric significance as the other two and users are therefore less likely to measure it. However, the information that makes up the mesh (e.g., a collection of point definitions and the edges that join them), does not directly reflect this difference in significance. For that reason, the mesh can be processed, when necessary, to distinguish geometrically significant points from others.

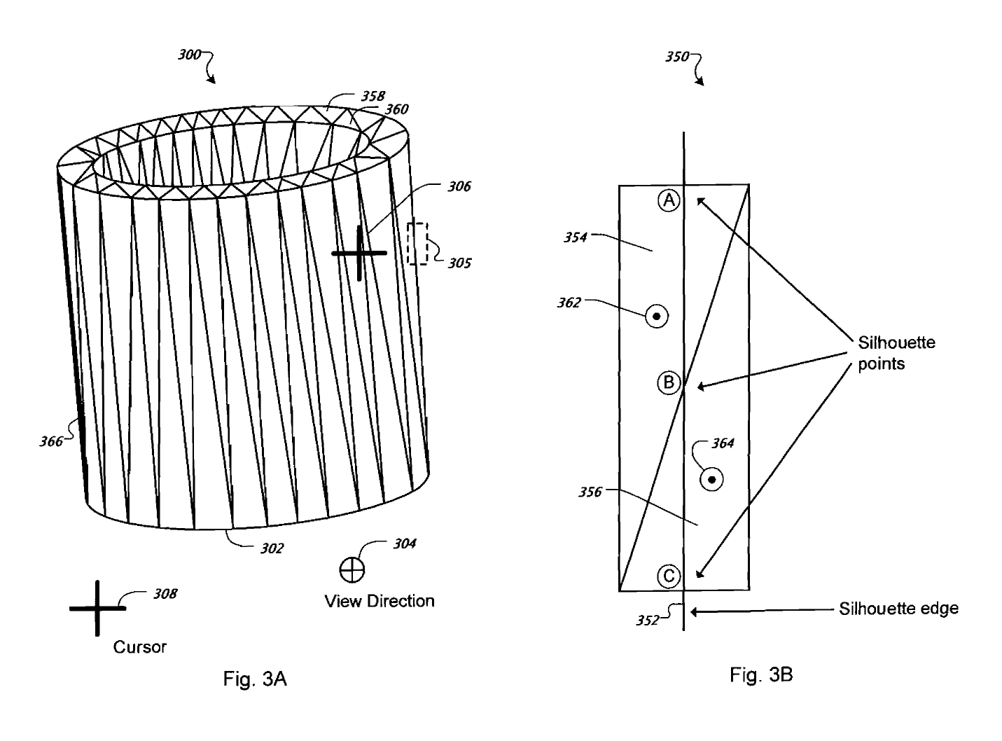

FIG. 3A shows an illustration 300 of an example cylinder 302, formed from a tessellated mesh. For example, the cylinder 302 is a mesh representation of a model received from a CAD program. The viewer program 114 here defines a view direction 304 that is the direction that the three-dimensional shape is displayed in by the viewer program. The view direction 304 schematically illustrates a view direction vector that is directed toward the mesh being displayed to the user. The user can change this direction relative to the presented shape so that the shape can be viewed from different angles. For example, the user could look at the cylinder 302 from the top, from the side or from various angles of rotation.

The snap processor 118 can search for and select features of interest on the cylinder 302. For example, the snap processor does this when a user points to the shape with a pointing device, because the user may then want to perform a measurement on the shape, if possible. An example of this process takes as input a mesh, the view direction 304 and the current cursor position, such as cursor 306 or cursor 308. The search process first determines if a ray that starts at the cursor and is oriented in the view direction intersects the mesh. For example, assume the current cursor position is cursor 308. The snap processor could determine that the cursor 308 does not intersect the mesh, in which case there is nothing of interest to select. In contrast, assume the current cursor position is cursor 306. The snap processor 118 could determine that the cursor 306 does intersect the mesh. The search process would then determine if the intersection point between the mesh and the ray is within some tolerance of one of the edges of the mesh. This tolerance is sometimes referred to as the snap distance and can be defined relative to the size of the entire mesh. For example, a snap distance of 5% of the mesh size can be defined. If there is no edge within the snap distance then there is no feature of interest to select other than the selected point itself. In contrast, if there is an edge within the snap distance, the snap processor will determine if that mesh edge is a part of a feature that is interesting to the user, as described below.

The cylinder 302 is here generated from triangles. However, its boundaries (as perceived by the user) do not necessarily correspond to edges of the triangles. For example, a silhouette portion 305 appears similar to the triangle edges in the mesh but is actually results from the three-dimensional curvature. That is, the actual side edge of the cylinder 302 may not be a part of the mesh. The side of the cylinder 302 is represented as triangles in the mesh, and depending on the rotation of the cylinder 302, a triangle edge may or may not correspond to the side edge of the cylinder 302. Any portion of the boundary that may or may not directly correspond to an edge is here called a silhouette.

FIG. 3B shows an illustration 350 of a silhouette edge 352 crossing triangle edges in the mesh. For example, the silhouette edge 352 can be located in the silhouette portion 305. Assume here that the user has placed cursor 306 in the silhouette portion 305. The snap processor can infer a silhouette edge by examining adjacent triangles near the cursor point to see if a silhouette crosses the triangles. For example, the snap processor can determine that the silhouette edge 352 crosses adjacent triangles 354 and 356 at points A, B and C. The snap processor 118 can also determine that a linear silhouette edge does not cross certain triangles. For example, the snap processor 118 can determine that the cylinder-side silhouette edge does not cross adjacent triangles 358 and 360 on the top rim of the cylinder.

More details regarding the silhouette inference algorithm are discussed below. The snap processor 118 can determine if a silhouette crosses an edge shared by two adjacent triangles by performing a test involving normal vectors associated with each triangle. This can be done using the well known technique of evaluating the angles formed between the view direction and the normal vectors of the two adjacent triangles. There, the edge is part of the object's silhouette if one of the angles formed by the surface normal and the view direction vector is obtuse and the other angle is acute.

For example, the snap processor can calculate a normal vector 362 for triangle 354 and a normal vector 364 for triangle 356. An angle can then be defined between the view direction 304 and the normal vector for each triangle. If this angle is acute for one of the triangles at issue and obtuse for the adjacent triangle, then it is determined that a silhouette crosses the two triangles. Angle values can be calculated using the following formulas, where V is the view direction and N₁ and N₂ are the normal vectors for the first and second triangle, respectively:

Value1=SIGN(VN₁)

Value2=SIGN(VN₂)

Thus, the evaluation can take the dot product (or scalar product) between the view direction and the respective normal vector. If the values have the same sign, then both normal vectors are on the same side of the silhouette and accordingly the shared edge is not part of a silhouette. In contrast, if the signs are not the same, the normal vectors are on opposite sides of the silhouette and accordingly the silhouette falls between them. These calculations can be similarly repeated for adjacent triangles (according to a proximity criterion) until it has been determined what the silhouette looks like, or on the contrary, that there is no silhouetted within the snap distance.

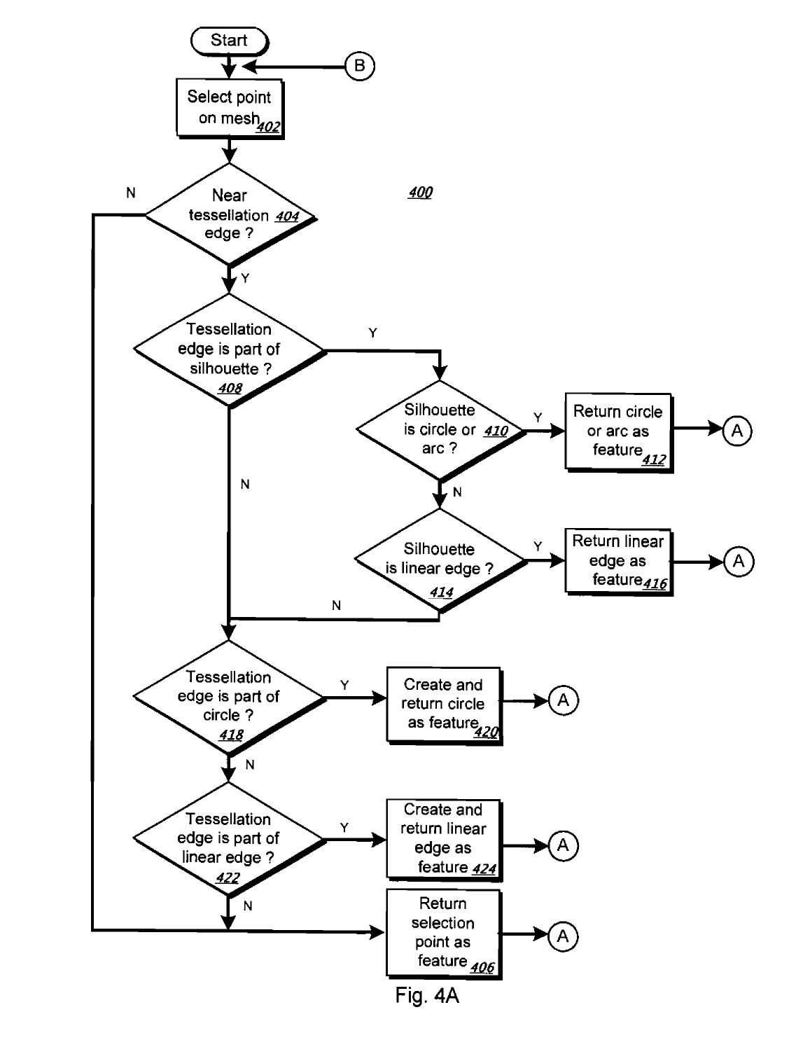

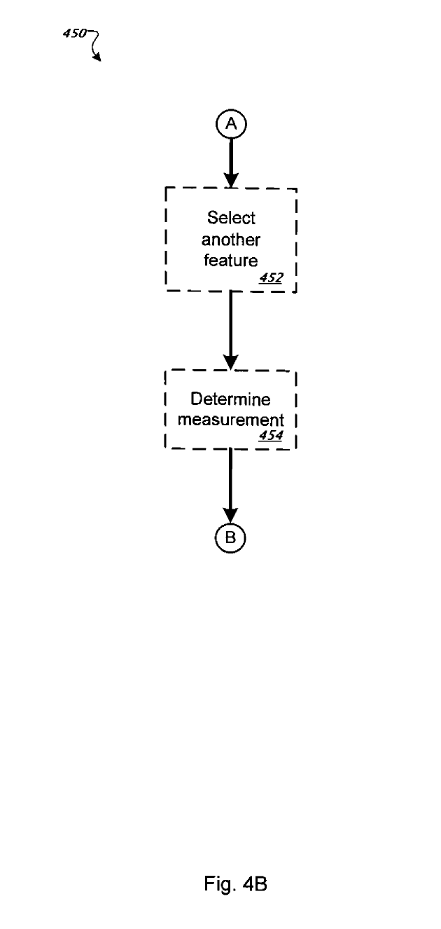

FIG. 4A is a flow chart for an exemplary method 400 that can be performed to identify features of interest on a shape represented by a tessellated mesh. The method can be performed by executing instructions stored in a computer program product. For example, the snap processor 118 of the viewer program 114 can perform the method 400. The method 400 begins in step 402 with the selection of a point on a shape represented by a tessellated mesh. For example, the user can select a point on the block shape 210 from FIG. 2 or on the cylinder shape 302 from FIG. 3. In contrast, it can be defined that the method should not be performed if a point outside the mesh is selected, such as with the cursor 308.

In step 404, it is determined whether or not the selected point is near a tessellation edge. This can be based on a snap distance or other closeness criterion. If the selection point is not near a tessellated edge the method 400 proceeds to step 406 where the selection point is returned as the feature of interest. For example, suppose the selection point is in the middle of the triangle 214E of the block shape 210 in FIG. 2. Suppose also that the distance from the selected point to any tessellated edge is greater than the snap distance. In this case the selection point would be returned since it is not sufficiently near a more significant feature of interest.

If, upon performing step 404, it is determined that the selection point is near a tessellated edge, the method 400 can search for other features of interest, as will now be described. In step 408, it is determined whether or not any tessellation edge near the selection point is part of a silhouette. For example, a tessellation edge is part of a silhouette if a silhouette edge crosses it. This can be determined as described with reference to FIG. 3. The mesh is processed and one or more triangles near the selection point are identified. For example, a test can be performed by examining an angle value formed between the view direction 304 and the respective normal vector associated with each triangle. If this angle is acute for one triangle and obtuse for the adjacent triangle then it has been determined that a silhouette crosses the two triangles. This angle can, for example, be determined by calculating the product between the view direction and the respective normal vector.

If, upon performing step 408 it is determined that a nearby tessellation edge is part of a silhouette, the method 400 will next determine in step 410 if the silhouette is a circle or an arc. An example of a circle silhouette occurs when viewing a three-dimensional sphere. That is, the boundary of the sphere as seen by a user is a circle, although this circle may or may not directly correspond to the individual triangle edges that make up the mesh. An example set of steps for determining a circular silhouette is described below. The previous determination of the presence of a silhouette yielded a set of silhouette points. For example, in FIG. 3, the identification of silhouette edge 352 yielded points A, B and C which lie on the silhouette. The method 400 in step 410 would continue testing adjacent triangles identified using a proximity criterion. With each pair of triangles found to be crossing a silhouette the resulting silhouette points can be tested to see if they lie on a circle formed by previously collected points. The process can terminate when either none of the adjacent triangles cross the silhouette, the silhouette point found does not lie on the circle with the other points collected so far (which means the silhouette is not a circle or an arc has been identified) or when the search for an adjacent triangle returns a triangle that has already been tested (closing the circle). If the silhouette is a circle or an arc such a silhouette will be returned in step 412 as the feature of interest. For example, this can involve highlighting the silhouette so that the user can see the feature that has been selected.

If, in step 410, it is determined that the silhouette is not a silhouette circle or a silhouette arc the method 400 will test in step 414 whether or not the silhouette is a linear edge. An example of a linear silhouette edge is the side edge silhouette 352 of the cylinder 302 discussed above with reference to FIG. 3. The process for detecting a linear silhouette edge can be similar to the process for detecting a circular silhouette in step 410. Adjacent triangles can be processed, silhouette points found can be collected, and tests can be performed to see whether silhouette points form a linear edge. If the silhouette is a linear edge it will be returned in step 416 as the feature of interest. For example, assume that the user has placed cursor 306 near silhouette edge 366 on cylinder 302. Upon the above selection, the linear silhouette edge 366 can be highlighted, for example in bold as shown in FIG. 3A.

If, upon completing step 408, it is determined that the tessellation edge is not part of a silhouette, or if upon completing step 414 it is determined that a silhouette found is not a linear edge, then the method 400 will next test in step 418 if the tessellation edge is part of a circle. Within a tessellated mesh a circle is represented as a collection of connected edges. For example, the circle hole in the block shape 202 of FIG. 2 is represented as a collection of edges, including edges of triangles 216A, 216B and 216C. Additionally, the circle hole in the top of the cylinder 302 is also represented as a collection of edges, including an edge from mesh triangle 360. In step 418, all tessellation edges within the snap distance will be collected and connected edge paths will be tested to see if an edge path forms a circle. The process terminates when no further edges can be found that lie on the circle formed from previously collected edges or if the circle becomes closed. If the tessellation edge is part of a circle it will be returned in step 420 as the feature of interest. For example, the mesh can contain a set of connected edges forming a circle, but the measurement operation needs the plane of the circle, its center point and its radius. Therefore, the circle can be created in step 420 and this information is then returned as the selected feature. If the tessellation edge is not part of a circle the method 400 will test to see if the edge is part of a linear edge, as will now be described.

In step 422, the method 400 will collect all tessellation edges within the snap distance and connected edge paths will be tested to see if an edge path forms a linear edge. Due to the tessellation process used in creating a mesh a linear edge may get broken into many connected pieces. The method 400 will find the longest set of edges forming a linear edge. Linear edges are further processed to remove non-important edges. For example, the two longer edges of triangle 214A can be considered non-important edges because they do not correspond to semantic edges of shape 210. In contrast, the third edge of the triangle 214A corresponds to a semantic edge of shape 210 because it forms part of the hole, and can therefore be considered an important linear edge. To test for important edges, the method 400 tests the triangles on either side of a tessellation edge to see if the adjacent triangles are close to planar. For example, the normal vectors can be used in determining planarity. If the two triangles are close to planar then the line is not considered important. If a tessellation edge is determined to be part of an important line then the line will be returned in step 424 as the feature of interest. If it is determined that a linear edge is to be returned the snap process will perform an additional test to determine if the selection point is near one of the endpoints of the edge. If an endpoint is within the snap tolerance then that endpoint is returned as the interesting feature.

In contrast, if the tessellation edge is determined to not be part of an important line then the method 400 has determined that no features of interest exist near the selection point. As a result, the selection point itself is returned in step 406 as the feature of interest. The method can be repeated to select a new feature of interest after the cursor is moved.

FIG. 4B shows a method 450 containing optional processing steps related to feature measurement. Method 450 starts at marker A, which corresponds to any and all of the markers labeled A on FIG. 4A. The A marker indicates a state where a feature has been selected. In step 454, the measurement processor 120 responds to a user measurement request to perform a measurement on the mesh. For example, if a circle is the selected feature the measurement operation can measure the radius of the circle and display the radius information near the circle. As another example, if a linear edge is the selected feature, the measurement processor 120 can measure and display the length of the linear edge.

While in a state with one feature selected, the user may optionally select another point on the mesh. The selection is here represented by a step 452. For example, step 452 can be performed upon the user moving the cursor, the step comprising the performance of some or all steps of the method 400 for the newly selected point. The user can then request that a measurement operation be performed on the two selected features. If so, the measurement processor 120 can determine and display a measurement result in step 454. Examples of measurement between two features include: determining an angle formed between two non parallel linear edges, determining the distance between a circle and a linear edge, determining the distance between two circles, determining the distance between two points, or determining the distance between two parallel linear edges.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer-readable medium. The propagated signal is an artificially generated signal, e.g., a machine-generated electrical, optical, or electromagnetic signal, that is generated to encode information for transmission to suitable receiver apparatus for execution by a computer. The computer-readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, in a viewer application executed by a processor, information that corresponds to a mesh of polygons representing a three-dimensional shape having at least one face, the information generated by a computer-aided design application that is configured for three-dimensional modeling, wherein the viewer application is not configured to perform the three-dimensional modeling;
displaying, on a display device controlled by the processor, a view generated by the viewer application that includes the three-dimensional shape having the at least one face and defined by the mesh of polygons, wherein the received mesh of polygons does not include any semantic information identifying the face and defining where any visible transition feature is located in the three-dimensional shape;
receiving, using the processor and while the three-dimensional shape is displayed and before the semantic information is obtained, a first input generated by a user selecting a point in the view generated by the viewer application;
searching polygons of the mesh near the selected point using the processor, in response to the first input, to determine whether the visible transition feature of the displayed three-dimensional shape is located near the selected point; and
generating an output by the viewer application on the display device that indicates an outcome of the search.

2. The method of claim 1, wherein searching the polygons of the mesh comprises determining whether the three-dimensional shape has a silhouette near the selected point.

3. The method of claim 2, wherein determining whether the three- dimensional shape has a silhouette near the selected point comprises:
determining an angle between a normal vector of a first polygon and a view direction defined in the view, the first polygon including the selected point, and determining an angle between a normal vector of a second polygon and the view direction, the second polygon being adjacent the first polygon, wherein the three-dimensional shape is determined to have a silhouette near the selected point if one of the angles is acute and another one of the angles is obtuse.

4. The method of claim 3, wherein determining whether the three- dimensional shape has a silhouette near the selected point further comprises iteratively evaluating adjacent polygons to determine whether the silhouette is a circle silhouette, an arc silhouette or a linear silhouette.

5. The method of claim 2, wherein it is determined that the three-dimensional shape does not have a silhouette near the selected point, further comprising determining whether the three-dimensional shape has a circle near the selected point.

6. The method of claim 5, wherein it is determined that the three-dimensional shape does not have a circle near the selected point, further comprising determining whether the three-dimensional shape has a linear edge near the selected point.

7. The method of claim 1, wherein no visual transition feature is determined to be located near the selected point in searching the polygons of the mesh, and wherein the output indicates that the selected point has been selected for a measurement operation.

8. The method of claim 1, wherein the visual transition feature is identified in searching the polygons of the mesh, and wherein the output includes the semantic information and indicates that the identified visual transition feature has been selected for a measurement operation.

9. The method of claim 8, further comprising performing the measurement operation using the selected visual transition feature and not using any additional visual transition feature.

10. The method of claim 9, wherein performing the measurement operation comprises (i) determining a property of a circle or arc, or (ii) determining a length of an edge.

11. The method of claim 8, wherein the user selects another point in the view, further comprising performing the measurement operation using (i) the selected visual transition feature, and (ii) the other selected point or another visual transition feature near the other selected point, the other visual transition feature identified by searching the polygons of the mesh.

12. The method of claim 11, wherein performing the measurement operation comprises determining a distance between any two features selected from the group consisting of a circle, an arc and an edge.

13. A computer program product tangibly embodied in a tangible computer-readable medium and comprising instructions that when executed by a processor perform a method relating to measuring a mesh, the method comprising:
receiving, in a viewer application executed by a processor, information that corresponds to a mesh of polygons representing a three-dimensional shape having at least one face, the information generated by a computer-aided design application that is configured for three-dimensional modeling, wherein the viewer application is not configured to perform the three-dimensional modeling;
displaying, on a display device controlled by the processor, a view generated by the viewer application that includes the three-dimensional shape having the at least one face and defined by the mesh of polygons, wherein the received mesh of polygons does not include any semantic information identifying the face and defining where any visible transition feature is located in the three-dimensional shape;
receiving, using the processor and while the three-dimensional shape is displayed and before the semantic information is obtained, a first input generated by a user selecting a point in the view generated by the viewer application;
searching polygons of the mesh near the selected point using the processor, in response to the first input, to determine whether the visible transition feature of the displayed three-dimensional shape is located near the selected point; and
generating an output by the viewer application on the display device that indicates an outcome of the search.

14. A system comprising:
a user interface device;
a computer program product containing instructions that when executed generate a viewer application, wherein the viewer application receives information that corresponds to a mesh of polygons representing a three-dimensional shape having at least one face, the information generated by a computer-aided design application that is configured for three-dimensional modeling, wherein the viewer application is not configured to perform the three-dimensional modeling; and
one or more computers operable to interact with the computer program product and the user interface device and to cause the user interface device to present a view that includes the three-dimensional shape having the at least one face and defined by the mesh of polygons, wherein the received mesh of polygons does not include any semantic information identifying the face and defining where any visible transition feature is located in the three- dimensional shape, the one or more computers also being operable to search polygons of the mesh near a point in the view, in response to user selection of the point in the view, to determine whether the visible transition feature of the displayed three-dimensional shape is located near the selected point, and generate an output by the viewer application that indicates an outcome of the search for presentation on the user interface device.

15. The system of claim 14, wherein the one or more computers comprise a server operable to interact with the user interface device through a data communication network, and the user interface device is operable to interact with the server as a client.

16. The system of claim 14, wherein the one or more computers comprises one personal computer, and the personal computer comprises the user interface device.
